(19) United States
(12) Patent Application Publication
(10) Pub. No.: US 2016/0233577 A1
(43) Pub. Date: Aug. 11, 2016

(54) HF Antenna for Rotor Wing Aerial Vehicles

(71) Applicants: Artem Saakian, Lusby, MD (US); Saad Tabet, Lusby, MD (US)

(72) Inventors: Artem Saakian, Lusby, MD (US); Saad Tabet, Lusby, MD (US)

(73) Assignee: United States of America as represented by the Secretary of the Navy, Patuxent River, MD (US)

(21) Appl. No.: 14/277,142

(22) Filed: May 14, 2014

(51) Int. Cl. H01Q 1/28

(52) U.S. Cl. CPC H01Q 1/28

(57) ABSTRACT

A HF antenna for rotor wing aerial vehicles which includes a plurality of circularly configured arcs, where each arc has a first end and a second end, the first end is attached to one of the blades, the second end is attached to another blade that is adjacent to the blade attached to the first end, such that each blade of the vehicle is attached to one first end of one of the arcs and one second end of another arc.

### STATEMENT OF GOVERNMENT INTEREST

The invention described herein may be manufactured and used by or for the Government of the United States of America for governmental purposes without payment of any royalties thereon or therefor.

### BACKGROUND

Typically high frequency (HF) communication on rotary wing aerial vehicles is accomplished via a towel bar type antenna. The towel bar is mounted on the fuselage of the rotary wing aerial vehicle. While effective at higher frequencies, towel bar antennas do not operate efficiently in the 2-4 MHz range where impedance matching and radiation pattern issues result in significant wasted energy and poor communication quality. Additionally towel bar antennas sometimes lose their ability to transmit in certain directions.

In general, one of the most important characteristics of an antenna is its transmit/receive polarization. There are two basic types of linear polarization formats, vertical and horizontal. A vertically polarized antenna transmits/receives vertically polarized signals, but cannot transmit/receive horizontally polarized signals. Similarly, a horizontally polarized antenna can only transmit/receive horizontally polarized signals.

Circular polarization is a combination of vertical and horizontal polarizations. Circular polarization of an electromagnetic wave is, but without limitation, a polarization where the tip of the electric field vector, at a fixed point in space, describes a circle as time progresses. A circularly polarized antenna has the ability to transmit/receive vertical signals, horizontal signals or a simultaneous combination thereof. This provides circularly polarized antennas the versatility to transmit/receive all types of polarizations, without being blind to any type of signal polarization.

Due to the motion and maneuvering of a helicopter (rotor wing aerial vehicle), a radio frequency (RF) signal can change polarization continuously from vertical to horizontal and vice versa. This causes intermittent loss of communications. Therefore, circular polarization must be utilized on a rotor wing aerial vehicle.

### SUMMARY

The present invention is directed to a HF antenna for rotor wing aerial vehicles the needs enumerated above and below.

The present invention is directed to a HF antenna for rotor wing aerial vehicles which includes a plurality of circularly configured arcs, where each arc has a first end and a second end, the first end is attached to one of the blades, the second end is attached to another blade that is adjacent to the blade attached to the first end, such that each blade of the vehicle is attached to one first end of one of the arcs and one second end of another arc.

It is a feature of the invention to provide a HF antenna for rotor wing aerial vehicles that significantly improves performance in the 2-4 MHz range compared to traditionally employed towel bar antennas and works for all modes of HF propagation.

It is a feature of the invention to provide a HF antenna for rotor wing aerial vehicles that can be used on every type of rotor wing aerial vehicle (manned or unmanned) and is a circularly polarized antenna.

It is a feature of the present invention to provide a HF antenna for rotor wing aerial vehicles that offers significant radiation efficiency improvement, improved radiation resistance and reactance, and increased antenna gain.

### DRAWINGS

These and other features, aspects and advantages of the present invention will become better understood with reference to the following description and appended claims, and accompanying drawings wherein

FIG. 1 is a perspective view of a rotor wing aerial vehicle with an HF antenna attached; and,

FIG. 2 is a top perspective view of the blades with the HF antenna.

### DESCRIPTION

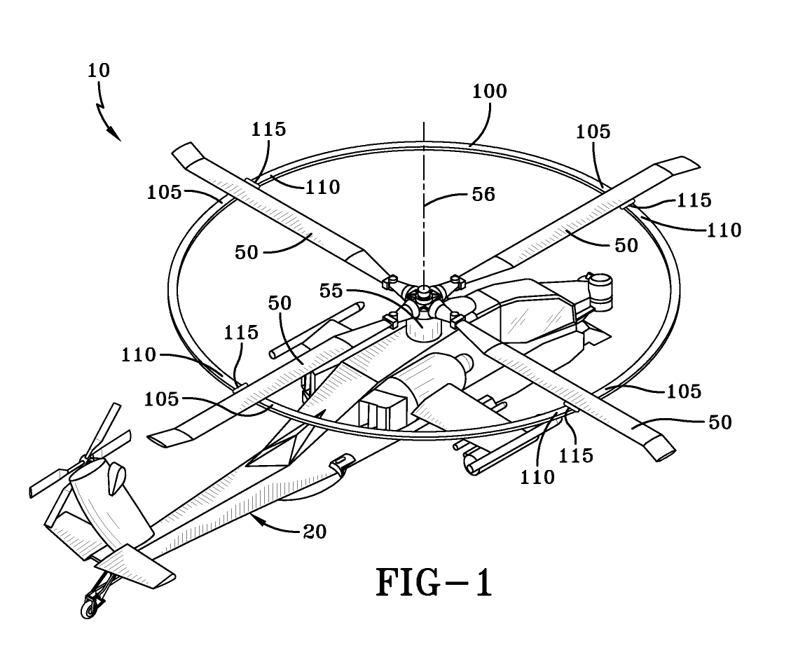

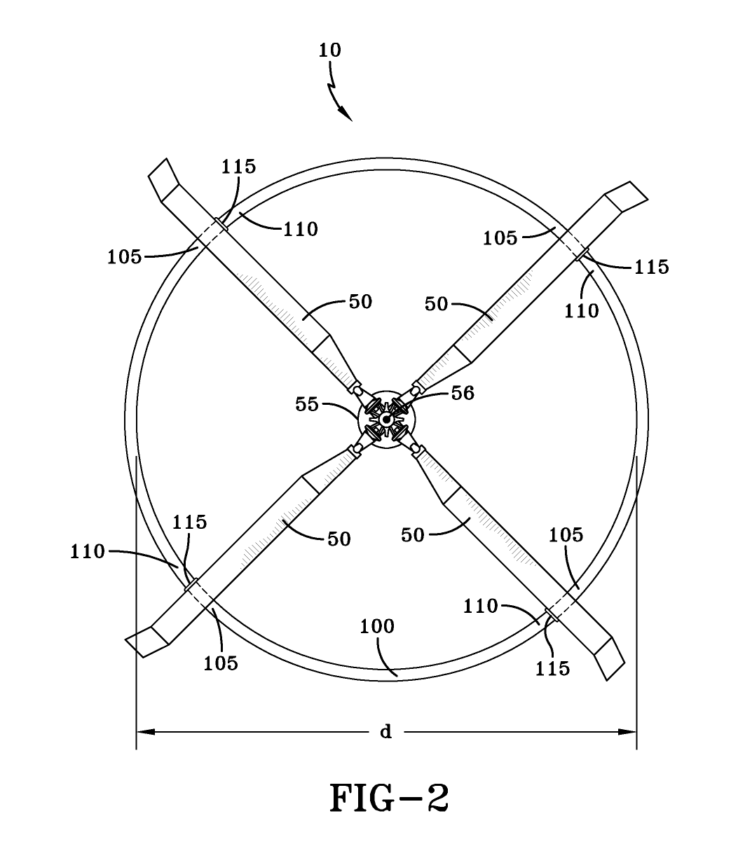

The preferred embodiments of the present invention are illustrated by way of example below and in FIGS. 1 and 2. The HF antenna for a rotor wing aerial vehicle 10 is for an aerial vehicle 20 with a plurality of blades 50. As shown in FIGS. 1 and 2, the HF antenna for a rotor wing aerial vehicle 10 includes a plurality of circularly configured arcs 100, each arc having a first end 105 and a second end 110, the first end 105 attached to one of the blades 50, the second end 110 attached to another blade 50 that is adjacent to the blade attached to the first end 105, such that each blade of the vehicle is attached to one first end 105 of one of the arcs 100 and one second end 110 of another arc 100.

In the description of the present invention, the invention will be discussed in a military aircraft environment; however, this invention can be utilized for any type of application that requires a HF antenna for a rotor wing aerial vehicle.

In the preferred embodiment of the HF antenna for a rotor wing aerial vehicle 10, the number of circularly configured arcs 100 is equal to the number of blades 50. Each arc 100 is attached to two adjacent blades 50 forming a blade-arc-blade sectorial loop. Optimally, as shown in FIGS. 1 and 2, each arc end is attached on opposite sides of each blade 50.

Each arc 100 is a conducting arc and may be a wire. The preferred embodiment of each circularly configured arc 100 is manufactured from highly conductive lightweight material such as, but without limitation, aluminum. Each arc 100 may also be a hollow tube. As shown in FIG. 1, the rotor wing aerial vehicle 20 has a main rotor 55 with a main rotor axis 56. Each arc 100 is mounted in a plane that the main rotor is in and the antenna 10 is centered on the main rotor axis 56. Additionally, the antenna 10 has a diameter. The diameter of the antenna 10 is any straight line segment that passes through the center of the circle created by all the blade-arc-blade sectorial loops and whose endpoints lie on the circle. The diameter (shown as d in FIG. 2) of the antenna 10, centered about the main rotor axis 56, is optimally 160 inches or greater. Additionally, the antenna 10 has a circular polarization.

An antenna requires radio frequency (RF) energy to be provided to it from a signal power source. Such RF signal is usually provided through a cable that connects the power source to the antenna. The point where the cable connects to the antenna and provides RF power is known as the antenna feed point. Each arc 100 includes a feed point 115. A feed point can be described, but without limitation, as a point on the arc 100 where the arc 100 is energized from a power supply. The HF antenna 10 may include a HF signal power source (not shown) such that the HF signal source power is equally split and supplied to each feed point 115 of each arc 110. The phase of the signal should be increased by a constant value related to the total number of blades 50 from one arch to the next. The increment in phase from arc to arc must be equal to 360/N, where N is the number of blades.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A HF antenna for a rotor wing aerial vehicle, the vehicle having a plurality of blades, the antenna comprising:
a plurality of circularly configured arcs, each arc having a first end and a second end, the first end attached to one of the blades, the second end attached to another blade that is adjacent to the blade attached to the first end, such that each blade of the vehicle is attached to one first end of one of the arcs and one second end of another arc.

2. The HF antenna of claim 1, wherein the antenna has a circular polarization.

3. The HF antenna of claim 2, wherein the number of circularly configured arcs is equal to the number of blades.

4. The HF antenna of claim 3, wherein each arc is attached to two adjacent blades forming a blade-arc-blade sectorial loop.

5. The HF antenna of claim 4, wherein the HF antenna includes a HF signal power source that supplies HF signal source power that is equally split and supplied to each of the arcs.

6. The HF antenna of claim 5, wherein each arc has a feed point to obtain HF signal source power from the HF signal power source.

7. The HF antenna of claim 6, wherein the rotor wing aerial vehicle has a main rotor with a main rotor axis, each arc is mounted in a plane that the main rotor is in and the antenna is centered on the main rotor axis.

8. The HF antenna of claim 7, wherein the rotor aerial vehicle has at least three blades.

9. The HF antenna of claim 8, wherein the antenna has a diameter centered about the main rotor axis and the diameter is at least 160 inches.
